(19) United States
(12) Patent Application Publication
(10) Pub. No.: US 2008/0244464 A1
(43) Pub. Date: Oct. 2, 2008

(54) Duplicating the Position of a Pointer Icon

(75) Inventor: Edward John Slattery, Chandlers Ford (GB)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 12/137,681

(22) Filed: Jun. 12, 2008

(30) Foreign Application Priority Data
Jun. 13, 1997 (GB) 07110164.6

(51) Int. Cl. G06F 3/048

(52) U.S. Cl. 715/856

(57) ABSTRACT

A method, apparatus and software is disclosed which enables the position of a pointer icon on a first display to be duplicated on one or more other displays.

### FIELD OF INVENTION

The present invention relates to a method, apparatus or software for duplicating the position of a pointer icon in a first display window, in one or more other display windows.

### BACKGROUND OF THE INVENTION

Computer systems that provide conferencing facilities enable data to be presented to a group of viewers under the control of a presenter via a set of networked computers. The presenter generally controls the data that is presented to viewers via one of the computers in the network and the data is presented to the viewers via one or more of the other computers on the network. The presenter's computer is provided with a mouse or track pad that enables the presenter to manipulate the position of a pointer icon within a display window displaying the presentation data. The presenter can move the pointer icon to indicate or highlight elements of the data to the viewers. The conferencing system is arranged to ensure that the presentation data and the position of the pointer icon in the presenter's display window is duplicated in the display windows of the other computers being viewed by the conference viewers.

One problem with such existing arrangements is that network lag can result in the update of the data and the position of the pointer icon being delayed. This lag reduces the quality of the presentation to the affected viewers. Furthermore, specific conferencing software is required on the presenter's and viewer's computers to provide the conferencing facilities.

### SUMMARY OF THE INVENTION

An embodiment of the invention provides a method for duplicating the position of a pointer icon in a first display window, in one or more other display windows, the method comprising: monitoring the position of a first pointer icon in a first display window displaying a set of display data; updating position data for the pointer icon, the position data representing the current position of the pointer in the first display window; periodically retrieving the position data; and displaying the set of display data in a second display window and positioning a second pointer icon in the second display window in accordance with the retrieved position data so as to substantially duplicate the position of the first pointer icon in the first display window relative to the set of display data.

The updating of the position data may be asynchronous with loading of the display data for display. The position data may be updated via HTTP to a server application program. The position data may be updated via a XMLHttpRequest API. The display data may be a web page and is displayed with an Ajax compliant web browser application program. The position data may be only updated in response to a detected movement of the pointer icon. The position data may be only retrieved if it has been updated since the immediately prior retrieval.

Another embodiment provides a method for duplicating the position of a pointer icon in a first display window, in one or more other display windows, the method comprising the steps of: receiving position data, the position data representing the position of a first pointer icon in a first display window displaying a set of display data; recording the position data; receiving periodic requests for the position data; and in response to each the requests, providing the position data so as to enable a second pointer icon to be positioned in the second display window displaying the set of display data in accordance with the position data so as to duplicate the position of the first pointer icon in the first display window relative to the set of display data.

A further embodiment provides apparatus for duplicating the position of a pointer icon in a first display window, in one or more other display windows, the apparatus being operable to: monitor the position of a first pointer icon in a first display window displaying a set of display data; update position data for the pointer icon, the position data representing the current position of the pointer in the first display window; periodically retrieve the position data; and display the set of display data in a second display window and positioning a second pointer icon in the second display window in accordance with the retrieved position data so as to substantially duplicate the position of the first pointer icon in the first display window relative to the set of display data.

Another embodiment provides apparatus for duplicating the position of a pointer icon in a first display window, in one or more other display windows, the apparatus being operable to: receive position data, the position data representing the position of a first pointer icon in a first display window displaying a set of display data; record the position data; receive periodic requests for the position data; and in response to each the request, to provide the position data so as to enable a second pointer icon to be positioned in the second display window displaying the set of display data in accordance with the position data so as to duplicate the position of the first pointer icon in the first display window relative to the set of display data.

A further embodiment of the invention provides a program or a group of programs arranged to enable a programmable device or group of such devices to perform a method for duplicating the position of a pointer icon in a first display window, in one or more other display windows, the method comprising the steps of: monitoring the position of a first pointer icon in a first display window displaying a set of display data; updating position data for the pointer icon, the position data representing the current position of the pointer in the first display window; periodically retrieving the position data; and displaying the set of display data in a second display window and positioning a second pointer icon in the second display window in accordance with the retrieved position data so as to substantially duplicate the position of the first pointer icon in the first display window relative to the set of display data.

Another embodiment provides a program or a group of programs arranged to enable a programmable device or group of such devices to perform a method for duplicating the position of a pointer icon in a first display window, in one or more other display windows, the method comprising the steps of: receiving position data, the position data representing the position of a first pointer icon in a first display window displaying a set of display data; recording the position data; receiving periodic requests for the position data; and in response to each the requests, providing the position data so as to enable a second pointer icon to be positioned in the second display window displaying the set of display data in accordance with the position data so as to duplicate the position of the first pointer icon in the first display window relative to the set of display data.

A further embodiment provides a program or a group of programs arranged to enable a programmable device or group of such devices to provide apparatus for duplicating the position of a pointer icon in a first display window, in one or more other display windows, the apparatus being operable to: monitor the position of a first pointer icon in a first display window displaying a set of display data; update position data for the pointer icon, the position data representing the current position of the pointer in the first display window; periodically retrieve the position data; and display the set of display data in a second display window and positioning a second pointer icon in the second display window in accordance with the retrieved position data so as to substantially duplicate the position of the first pointer icon in the first display window relative to the set of display data.

Another embodiment provides a program or a group of programs arranged to enable a programmable device or group of such devices to provide apparatus for duplicating the position of a pointer icon in a first display window, in one or more other display windows, the apparatus being operable to: receive position data, the position data representing the position of a first pointer icon in a first display window displaying a set of display data; record the position data; receive periodic requests for the position data; and in response to each the request, to provide the position data so as to enable a second pointer icon to be positioned in the second display window displaying the set of display data in accordance with the position data so as to duplicate the position of the first pointer icon in the first display window relative to the set of display data.

### BRIEF DESCRIPTION OF THE DRAWINGS

Embodiments of the invention will now be described, by way of example only, with reference to the accompanying drawings in which:

FIG. 1 is a schematic illustration of a computer system in which the position of a pointer icon in one display window is duplicated on other display windows;

FIG. 2 is a schematic illustration of the pointer duplicating system of FIG. 1; and

FIGS. 3, 4 and 5 are flow charts illustrating processing performed in elements of the system of FIG. 2.

### DETAILED DESCRIPTION

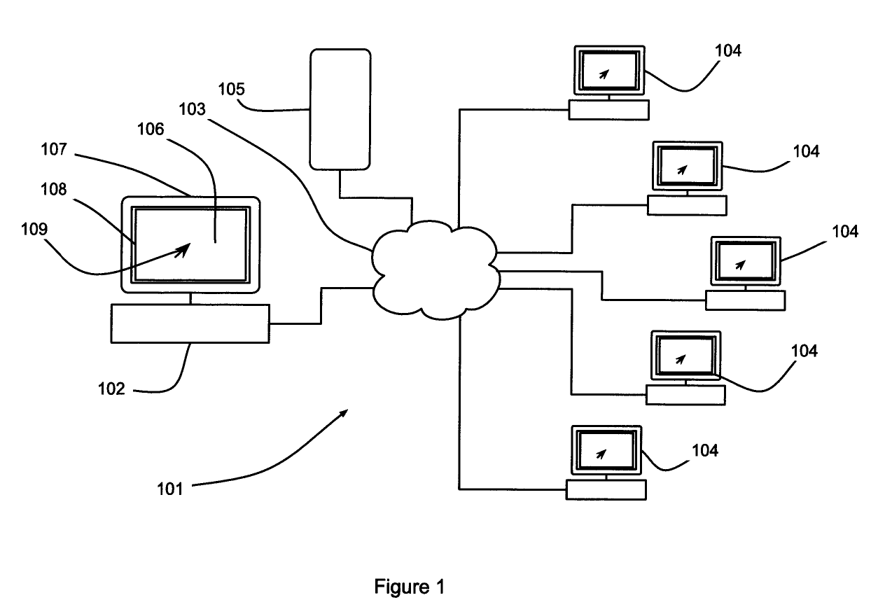

With reference to FIG. 1, a computer system 101 comprises a first computer 102 connected via a network 103 to five further computers 104. A server computer 105 is also connected to the network 103. The computers 103, 104, 105 are arranged to provide a conferencing system that enables a user, in the form of a presenter, to present display data 106, in the form of a web page, via the first computer 103 to a set of viewers via the displays of the five further computers 104. The first computer 102 comprises a display 107 on which the web page 106 is displayed in a display window 108 in the form of a web browser window.

The first computer also provides a pointer icon 109 in the display window 108 that can be manipulated by the presenter via a mouse or track pad (not shown). The pointer icon 109 and its control system are provided by the operating system of the first computer. Each of the further computers 104 also comprise displays on which web browser windows are provided to display the web page 106. The pointer icon 109 and its position in the browser window 108 of the first computer 102 relative to the display data 106 are duplicated on the displays of the further computers 104. Thus the position of the pointer icon 109 on the viewers' computers 105, may be manipulated by the presenter via the first computer 102.

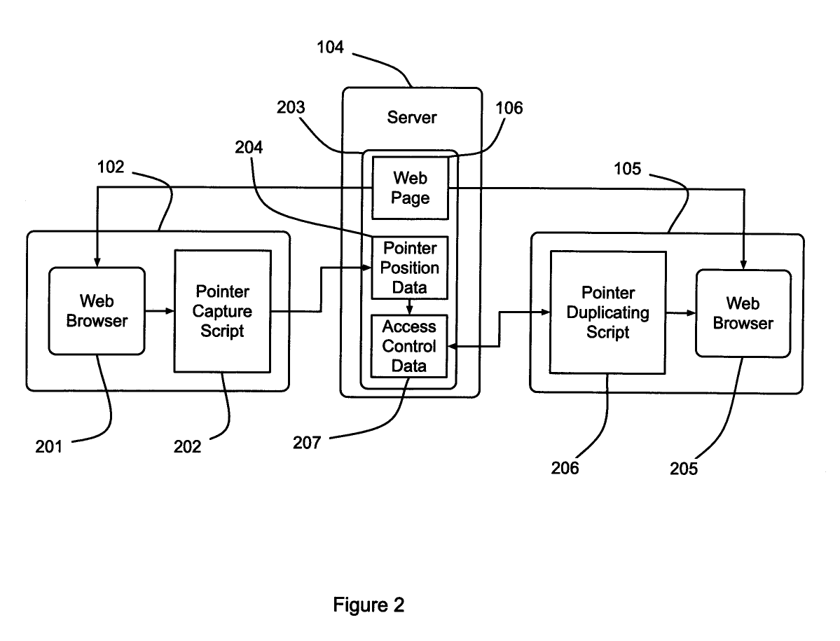

With reference to FIG. 2, the first computer 102 runs a web browser application program 201 in conjunction with a script 202 arranged to capture the position of the pointer icon 109. The pointer position capture script 202 is arranged to communicate with a web server application program 203 running on the server 104 to store data representing the position of the pointer icon 109 in the form of pointer position data 204. In the present embodiment, the web server application program 203 also stores the web page 106. The web page 106 is accessed using the web browser 201 via a Hypertext Transfer Protocol (HTTP) connection over the network 103. The web browser 201 is arranged to comply with the requirements of the Asynchronous JavaScript™ and XML framework (Ajax). The pointer capture script 202 is a JavaScript™ programme and uses a XMLHttpRequest Application Program Interface (API) to update the pointer position data 204. The XMLHttpRequest API enables the pointer position data 204 captured by the pointer capture script 202 to be passed to the web server application program 203 asynchronously of the loading of the web page 106.

Each of the further computers 105 runs an Ajax compliant web browser 205 and a JavaScript™ program in the form of a pointer duplicating script 206. The web browser 205 is arranged to display the web page 106. The pointer duplicating script 206 is arranged to poll the web server application program 203, via the XMLHttpRequest API for any updates to the pointer position data 204. The web server application program 203 is arranged to respond to the poll by providing any updated pointer position data 204. In response to the pointer position data 204, the pointer duplicating script is arranged to update the position the pointer icon on the browser window of the respective further computer 105 accordingly. The XMLHttpRequest API enables the pointer duplicating script 206 to poll for and receive the pointer position data and update the position of the pointer icon asynchronously of the loading of the web page 106. In other words, the position of the pointer icon on the further computers 105 is updated without reloading the web page 106.

The web server application program 203 further comprises access control data 207, which is used to control access over the network 103 to the pointer position data 204. The access control data identifies the Internet Protocol (IP) addresses of the computers, such as the further computers 105, that are permitted to access the pointer position data 204.

In the present embodiment, the pointer capture script 202 is downloaded from the server 104 when the presenter initiates the remote pointer following facility via a web interface provided by the web server application program 203. The pointer duplicating script 206 is associated with the web page 106 and is automatically downloaded from the server 104 when a permitted viewer downloads the web page 106.

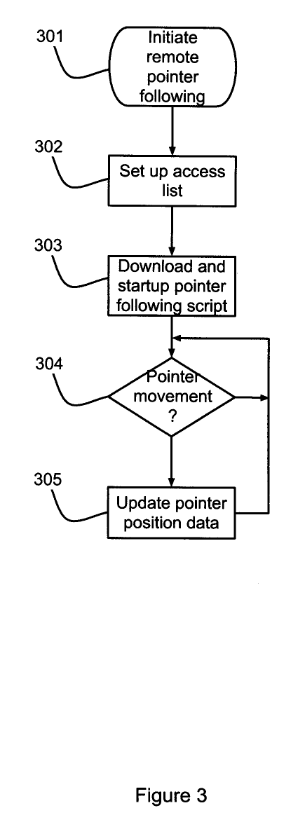

The processing performed when initializing and running the pointer capture script will now be described in further detail with reference to the flow chart of FIG. 3. At step 301, the remote pointer following facility is initiated by the presenter and processing moves to step 302. At step 302, the presenter is prompted to set up the access control list 207 and, once this set up is completed, processing moves to step 303 where the pointer following script 202 is downloaded from the server 104 along with the web page 106. Processing then moves to step 304 were the pointer following script 202 monitors the pointer icon 109 for any change in position. When any such change in the position of the pointer icon 109 is detected, processing moves to step 305 where the pointer position data 204 is updated accordingly on the server via the XMLHttpRequest API. Processing then returns to step 304 to continue monitoring the any further movement of the pointer icon 109 and continues as described above until another web page is viewed in the display window or the display window is closed down.

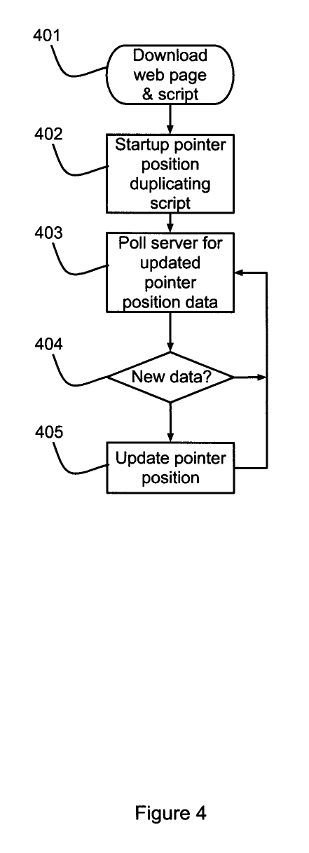

The processing performed when initializing and running the pointer duplicating script 206 will now be described in further detail with reference to the flow chart of FIG. 4. At step 401, the web page 106 and the pointer duplicating script 206 are downloaded from the server 104 in response to a user command via the web browser 205. Processing then moves to step 402 where the processing of the pointer duplicating script 206 is started and processing moves to step 403. At step 403, the web server application program 203 is polled for updated pointer position data 204 via the XMLHttpRequest API. In the present embodiment, the pointer duplicating script 206 is arranged to record a time stamp received with each set of updated pointer position data 204 from the web server application program 203. In step 403, the time stamp for the last received set of pointer position data 204 is included in each poll to enable the web server application program to only respond if the pointer position data 204 on the server 104 has been more recently updated. This time stamp mechanism saves unnecessary processing that would otherwise result from duplicated pointer position data. From step 403, processing moves to step 404 where, a 20 ms polling countdown timer is started. If new pointer position data 204 is received prior to the polling timer reaching zero then processing moves to step 405 where the position of the pointer is updated accordingly. If the polling timer reaches zero prior to any data being received then processing returns to step 403 where the processing proceeds to poll the web server application program 203 as described above. Processing then continues to duplicate the position of the pointer icon 109 as described above until another web page is viewed in the display window or the display window is closed down.

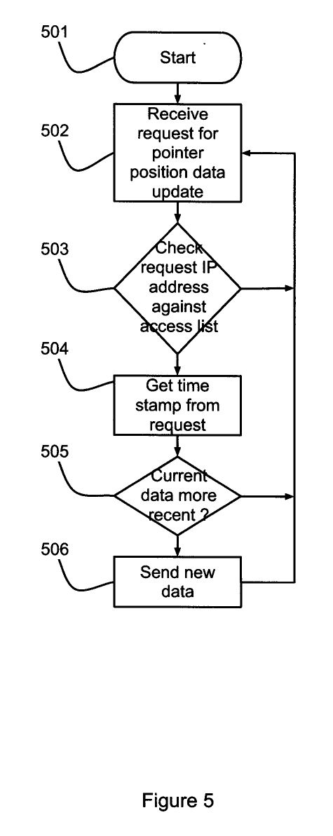

The processing performed by the web server application program 203 in response to polls from pointer duplication scripts 206 will now be described in further detail with reference to the flow chart of FIG. 5. Processing is initiated at step 501 in response the initiating of the pointer capture script 202 in step 303 as described above. Processing then moves to step 502 where processing waits for the receipt of a request for updated pointer position data 204 from a pointer duplication script 206. When a request is received, processing moves to step 503 where the IP address of the request is checked against the access control data 207. If the IP address is that of a permitted computer 105 then processing moves to step 504. At step 504, the time stamp from the request is extracted and processing moves to step 505 where the time stamp is compared to that of the latest update of the pointer position data 204. If the time stamp comparison step indicates that the pointer position data 204 has been updated since the time indicated by the received time stamp then processing moves to step 506 where the updated pointer position data 204, including its current time stamp, is sent to the requesting pointer duplication script 206. If at step 505 the time stamp comparison indicated that there has been no intervening update of the pointer position data 204 then processing returns to step 502 to await a further request as described above.

Embodiments of the invention enable the material to be presented over a computer or communications network without the need for specific conferencing technology. Furthermore, updating the view of the material being presented to viewers only requires the transmission of the pointer position data across the network. This transmission is asynchronous with the updating of the presentation material itself. The transmission of the pointer position data between the capture script and duplicating script is also asynchronous.

In another embodiment the pointer position data does not include a time stamp and the poll from the pointer duplicating script also omits the time stamp. In response to every poll, the web server application program provides the latest pointer position data regardless of whether it has been updated since the last poll.

In a further embodiment, the pointer capture or duplicating scripts are maintained with the respective web browser applications. Such scripts may be referred to as plug-in applications for the web browser.

In another embodiment, the downloading and processing of the pointer duplicating script is initiated via a button on the web page.

In a further embodiment, while the duplicated pointer icon may not be manipulated by a viewer, one or more further pointer icons may be provided for manipulation by the viewer.

In another embodiment, all web browsers in the system are provided with both pointer capture and duplicating scripts so as to provide each participant with a pointer icon that may be duplicated on one or more of the other computers displays in the system. For example, in a two participant communication, each party may have their pointer icon duplicated on the other's display resulting in two pointer icons appearing on each display. Each participant may have an individualised pointer icon having a unique colour, shape, animation or label. Each participant may select which pointer icons of the other participants to display on their own web browser. Each participant may select which of other participant's web browsers their own pointer icon may appear on.

In a further embodiment, the access control data is omitted enabling any viewer with access to the web page to also have access to the pointer icon duplication.

In another embodiment, the pointer position data is simply stored on a storage device connected to the network to enable the pointer position capture and duplicating scripts access to the data to respectively update or download the pointer position data without the need for a web server application program. A lock mechanism may also be provided to avoid simultaneous updating and downloading.

In some situations, a viewer may resize their browser window to a size smaller than that needed to display the complete web page. In a further embodiment, the pointer position duplicating script is arranged to detect when the pointer position data defines a position outside of the visible page on the viewers web browser. In this case, the script is arranged to issue suitable scrolling commands the web browser to bring the appropriate position into view so that the pointer can be visibly duplicated.

As will be appreciated by those skilled in the art, mechanisms other than the HTTP, and the XMLHttpRequest API may be used to provide pointer icon duplication where only the pointer position data or equivalent is transferred between the presenter's and viewer's displays.

As will be understood by those skilled in the art, the pointer position may be represented in a number of different but equivalent manners. For example, the new position may be represented relative to a prior position or as a directional velocity in the form of a vector. In the present description and claims, the term position data means any useful representation of position, relative position or moving position.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via any suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. A method for duplicating the position of a pointer icon in a first display window, in one or more other display windows, said method comprising:
monitoring the position of a first pointer icon in a first display window displaying a set of display data;
updating position data for said pointer icon, said position data representing the current position of said pointer in said first display window;
periodically retrieving said position data; and
displaying said set of display data in a second display window and positioning a second pointer icon in said second display window in accordance with said retrieved position data so as to substantially duplicate the position of said first pointer icon in said first display window relative to said set of display data.

2. A method according to claim 1 wherein the updating of said position data is asynchronous with loading of said display data for display.

3. A method according to claim 1 wherein said position data is updated via HTTP to a server application program.

4. A method according to claim 3 wherein said position data is updated via a XMLHttpRequest API.

5. A method according to claim 1 wherein said display data is a web page and is displayed with an Ajax compliant web browser application program.

6. A method according to claim 1 wherein said position data is only updated in response to a detected movement of said pointer icon.

7. A method according to claim 1 wherein said position data is only retrieved if it has been updated since the immediately prior retrieval.

8. A method for duplicating the position of a pointer icon in a first display window, in one or more other display windows, said method comprising:
receiving position data, said position data representing the position of a first pointer icon in a first display window displaying a set of display data;
recording said position data;
receiving periodic requests for said position data; and
in response to each said requests, providing said position data so as to enable a second pointer icon to be positioned in said second display window displaying said set of display data in accordance with said position data so as to duplicate the position of said first pointer icon in said first display window relative to said set of display data.

9. Apparatus for duplicating the position of a pointer icon in a first display window, in one or more other display windows, said apparatus being operable to:
monitor the position of a first pointer icon in a first display window displaying a set of display data;
update position data for said pointer icon, said position data representing the current position of said pointer in said first display window;
periodically retrieve said position data; and
display said set of display data in a second display window and positioning a second pointer icon in said second display window in accordance with said retrieved position data so as to substantially duplicate the position of said first pointer icon in said first display window relative to said set of display data.

10. Apparatus according to claim 9 wherein the updating of said position data is asynchronous with loading of said display data for display.

11. Apparatus according to claim 9 wherein said position data is updated to a server application program via HTTP.

12. Apparatus according to claim 11 wherein said position data is updated via a XMLHttpRequest API.

13. Apparatus according to claim 9 wherein said display data is a web page and is displayed with an Ajax compliant web browser application program.

14. Apparatus according to claim 9 wherein said position data is only updated in response to a detected movement of said pointer icon.

15. Apparatus according to claim 9 wherein said position data is only retrieved if it has been updated since the immediately prior retrieval.

16. Apparatus for duplicating the position of a pointer icon in a first display window, in one or more other display windows, said apparatus being operable to:
receive position data, said position data representing the position of a first pointer icon in a first display window displaying a set of display data;
record said position data;
receive periodic requests for said position data; and
in response to each said request, to provide said position data so as to enable a second pointer icon to be positioned in said second display window displaying said set of display data in accordance with said position data so as to duplicate the position of said first pointer icon in said first display window relative to said set of display data.

17. A computer program product arranged to enable a programmable device or group of such devices to perform a method comprising:
monitoring the position of a first pointer icon in a first display window displaying a set of display data;
updating position data for said pointer icon, said position data representing the current position of said pointer in said first display window;
periodically retrieving said position data; and
displaying said set of display data in a second display window and positioning a second pointer icon in said second display window in accordance with said retrieved position data so as to substantially duplicate the position of said first pointer icon in said first display window relative to said set of display data.
